(19) United States
(12) Patent Application Publication
(10) Pub. No.: US 2019/0138046 A1
(43) Pub. Date: May 9, 2019

(54) Array for hemispherical actuation

(71) Applicants: Patrick A. McFadden, Victoria (CA); Kyle A. Hagen, Victoria (CA); Mitchell Mctaggart, Victoria (CA); Owen J. Duncan, Victoria (CA)

(72) Inventors: Patrick A. McFadden, Victoria (CA); Kyle A. Hagen, Victoria (CA); Mitchell Mctaggart, Victoria (CA); Owen J. Duncan, Victoria (CA)

(21) Appl. No.: 15/732,400

(22) Filed: Nov. 7, 2017

(51) Int. Cl. G05G 9/047

(52) U.S. Cl. CPC G05G 9/047; G05G 2009/04755; G05G 2009/04707

(57) ABSTRACT

This invention relates to a machine and method to create force profiles within a two dimensional hemispherical plane. It utilizes an array of electromagnets to exert a magnetic force on a shaft that can pivot in two dimensions. The shaft rotates around the pivot point with one end inside the array of electromagnets and the other end exposed as a handle or end effector. The shaft end located within the array has a permanent magnet or electromagnet to receive a magnetic force from the array. The location of the shaft magnet relative to the array permits its location and force output to be controllable within its hemispherical range of motion. The position of the magnet is determined by Hall effect sensors that report the angular components of the shaft magnet's own magnetic field. The magnetic field of the force generating component is used both for motion and for sensing.

### CROSS-REFERENCE TO RELATED APPLICATIONS

This application claims the benefit of PPA 62,496,758 filed by the present inventors.

### FIELD OF THE INVENTION

The field of the present invention is related to the various disciplines such as computer engineering, electrical engineering, mechanical engineering and the general sciences. The invention is within the category of mechatronic devices. The invention is also related to general sciences via permanent magnet modeling.

The kind of devices within the field of this invention include robotic ball joints, waveguide steering apparatus, active handles, force activated steering wheels, joysticks, and magnetically actuated gimbals. The field also pertains to the software and circuitry to control the force and dynamic motion of these devices. For example, controlling the rotation of a joint to reach and hold a particular position while under a force load.

### BACKGROUND OF THE INVENTION

Practically all mechatronic machines are subject to wear, notably at bearing contacts and for any wiring used in connection with moving components. These problems affect the longevity and long term device cost. An example of this can be found in item 196 of R. L. Hollis's patent U.S 2011/0050405 shown in FIG. 3, where a wiring harness must continually move during operation. Prior art shows a continued pursuit in finding economic ways to reducing as many contact points as possible so that devices do not wear out. This can be seen in devices such as in T. M. Baker et al's U.S Pat. No. 5,421,694 for a non contacting joystick. Baker's invention is in the context of industrial joystick controls for backhoe equipment, where previous joysticks had to make physical contact with switches to determine its position, causing wear and operator fatigue.

Shown in FIG. 4 is a figure from K. M. Martins's U.S. Pat. No. 6,380,925. It is a joystick device giving output on a hemispherical plane and has contact points between its motors 62 and relating mechanisms that transfer the force from these motors to a manipulated object 14. This device will be subject to wear at these contact points and the fidelity of the force effects will be affected by the presence of mechanical backlash.

Another problem in the field is the complexity and cost associated with position sensing solutions for devices that can actuate within a hemi-spherical plane. Standard sensor solutions such as using potentiometers attached to a gimbal as suggested in C. Corcoran's patent US 2004/0124717 A1 will eventually wear and break. Many of the prior art devices require a separate apparatus or physical phenomena for their sensing solution, such as in R. L. Sanchez's device with U.S. Pat. No. 5,724,068, where optical sensors are used to determine the position of a Joystick that uses a mechanical spring to impart forces on a handle. Other complex solutions arise from trying to overcome this such as requiring extra magnetic components for the sole purpose of sensing such as in L. Logue's device in U.S. Pat. No. 5,559,432. Solutions for wearless sensors exist in the form using either optics, capacitance, inductance, or electric and magnetic field detection. Devices that use these solutions for hemispherical movement require an extra apparatus to implement the sensor, such as the sensor developed in J. W. Yang's patent U.S 2007/0242043 A1.

A machine will inherently struggle to precisely replicate force effects found in nature; a human operator is typically able to tell the difference between a machine generated effect in comparison to a force generated in nature. The force magnitude output of magnetic field based devices can be increased with the use of ferromagnetic materials. However, this will typically be at the cost of output cogging. Cogging is a parasitic, periodic force associated with the magnetic domains switching in ferromagnetic material and will interfere with a device's ability to convincingly reproduce natural force effects. Examples of prior art that use ferromagnetic material in order to enhance force output can be found in patents such as the spherical joint of D. Chassouliers in U.S. Pat. No. 6,251,048 81, the inner components of the DC motors used in D. F. Moore's U.S. Pat. No. 7,061,466 and D. C. Browns patent US 2002/0181851 A1. Due in part to codding, complex force effects such as detents are difficult to implement. Devices requiring expensive exotic phenomena such as the stiffening of Electrorheologic fluids have been used to achieve detents such as in V. E. Waggoner's U.S. Pat. No. 8,066,567 B2. Other devices employ a purely mechanical means to implement detents such as in G. L. MCauley et al's device U.S. Pat. No. 5,773,773.

Problems are also found in operator training where time in a real vehicle is either dangerous or expensive. The proper operation of any vehicle requires the operator to be familiar with the cueing they receive from their controls and have developed muscle memory for carrying out maneuvers. When devices are used to control vehicles in operation, they need to maintain their force effects while under inertial changes from the vehicle movements, such as the g-forces a handle would experience in an aircraft.

Another issue in these kind of devices is scalability. When different force profiles are needed, i.e for thumb operation or hand operation, most device designs cannot be economically scaled and introduced into society as different sizes. The Joystick of C. Corcoran's, V. E. Waggoner, D. F. Moores, and R. L. Sanchez's, and K. M. Martins would require multiple components to change in size, many components being discrete in nature and therefore requiring specialized engineering and procurement to produce various sizes of their claimed inventions.

### SUMMARY

The invention pertains to an input/output device capable of receiving and delivering force within a two dimensional hemispherical plane. This enables it to be useful in several scenarios, such as a controller or active joint. Among other problems, the invention addresses the cost associated with wear, the cost of requiring multiple components, cost of operator training, and the quality of force effects generated by a machine. The invention demonstrates reduced cost by using the same magnetic element for each axis of force generation, demonstrates increased quality of forces by omitting mechanical coupling, is scalable to multiple sizes, and further reduces cost and complexity by having the same magnetic element used for force generation to sense its own position.

### DRAWINGS

FIG. 1. Shows a perspective view of an embodiment of the invention.

FIG. 2. Shows inner components of the embodiment of FIG. 1.

FIG. 3. Prior art with a moving wiring harness.

FIG. 4. Prior art implementing a separate motor for each axis.

FIG. 5A. Figure to define the relative placement of the coils, magnets, and axes within the invention.

FIG. 5B. Force profile for optimizing the relative coil and magnet placement.

FIG. 6. Figure of magnet modeling for core magnet placement and shape.

FIG. 7A. Another embodiment of the invention where the magnet axis of the core magnet is perpendicular to the magnetic axis of the coils.

FIG. 7B. Magnetic axis arrangement of FIG. 7A.

FIG. 8. Mounting example for the embodiment of FIG. 8.

FIG. 9. An embodiment of the invention demonstrating the use of a ball joint instead of a gimbal.

### DETAILED DESCRIPTION

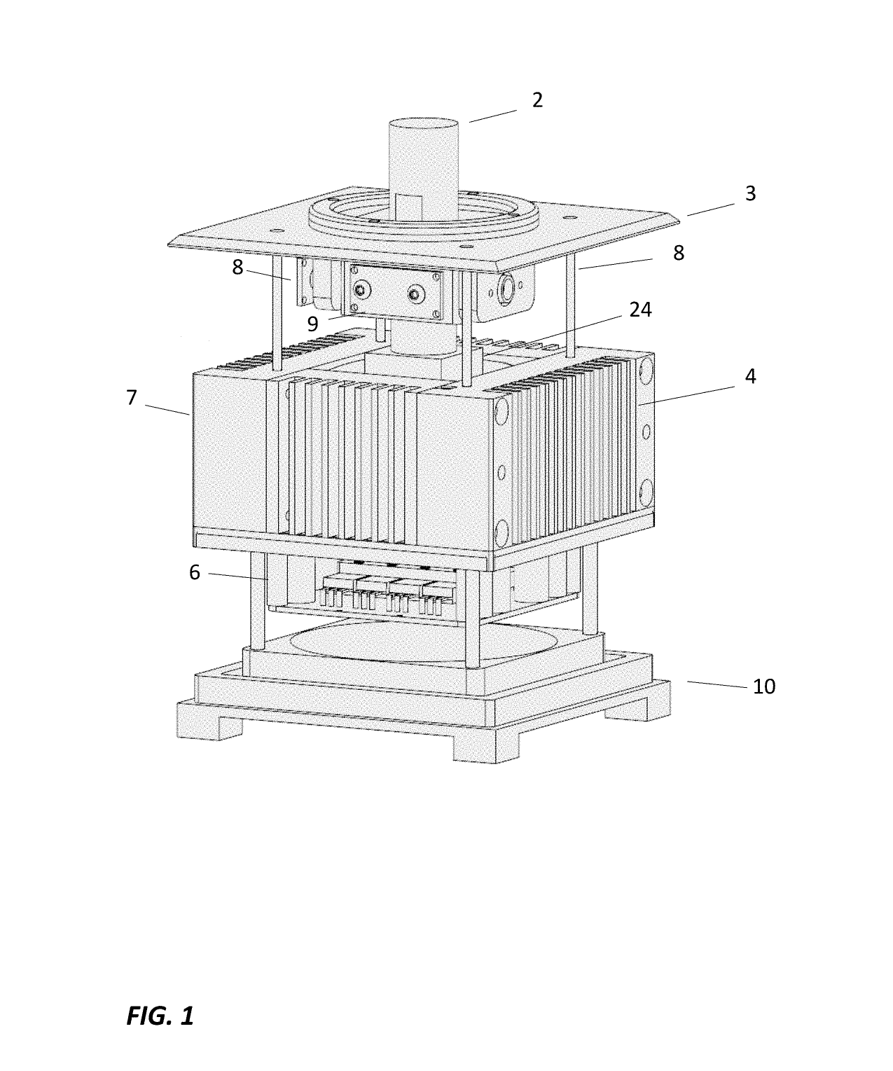

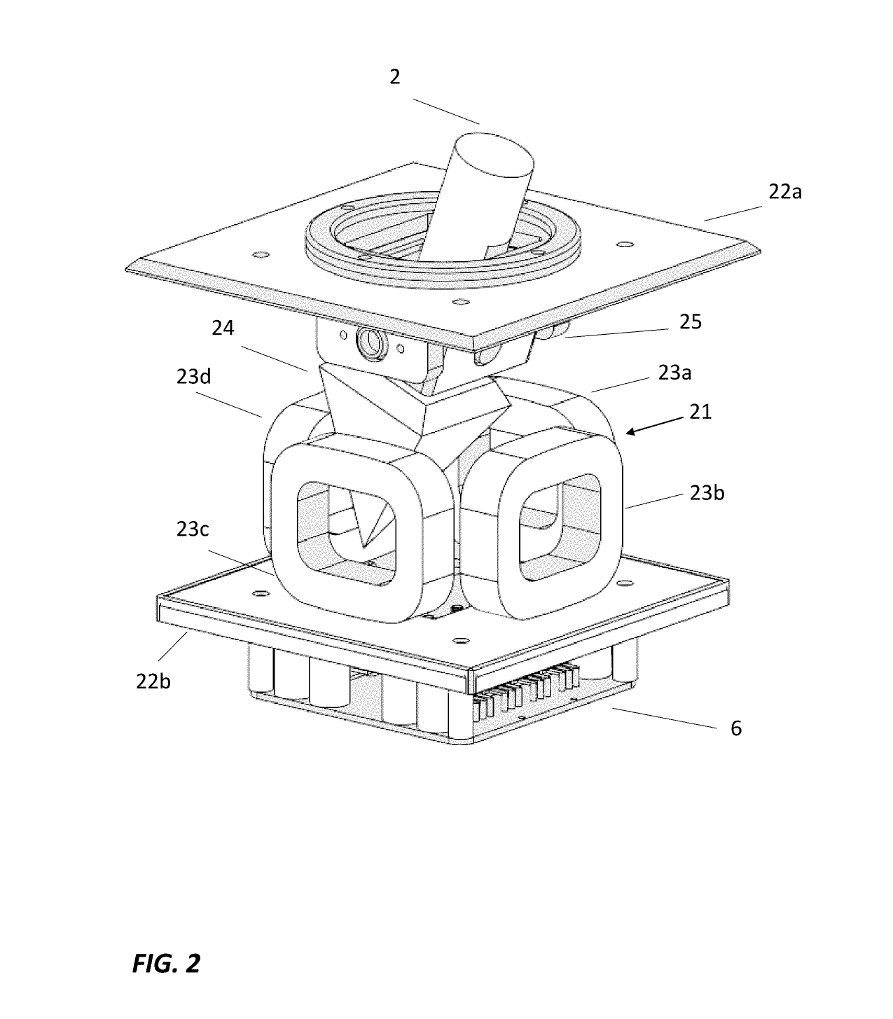

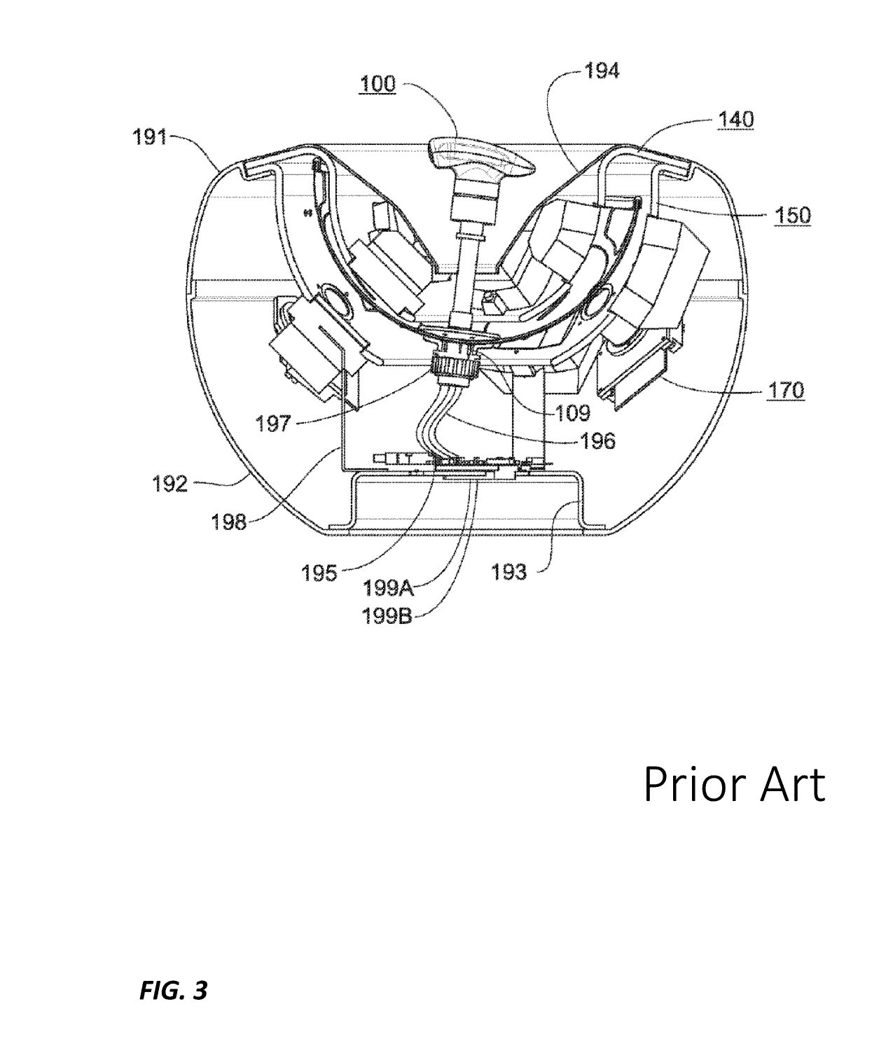

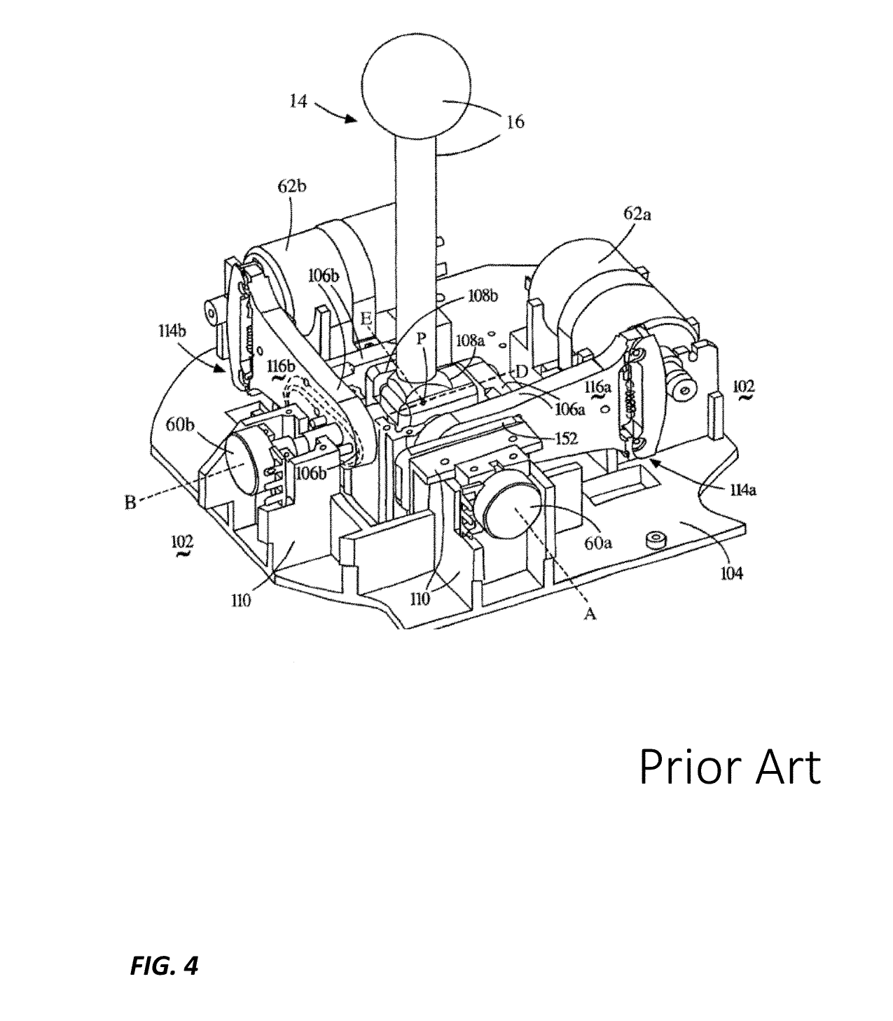

The invention relates to the ability to control the position and force output of a shaft within a hemispherical plane. FIG. 1. shows an embodiment of the invention where a permanent core magnet or electromagnet 24 is acted on by electromagnetic coils within heat conductive housing 7 including finned walls 4. The coils receive variable power from controller board 6. The embodiment may be cooled from below by placing a fan within fan housing 10. The position of the core magnet is sensed using X-axis sensor 8 and Y-axis sensor 9. The embodiment receives and produces force via end effector or shaft 2. The controller board 6 is in electrical connection with each of the coils and sensor boards via a stationary wire connection that may be placed within connector post 8. FIG. 2. shows Inner components of the embodiment of FIG. 1. The coil array 21 is composed of coils exposed in the figure as 23a, 23b, 23c, and 23d. The coils are not limited to the size and prism shape as shown, they are each wound such that their magnetic axis points directly towards the neutral position of core magnet 24. The core magnet 24 may be mounted to end effector 2 using only magnetic attraction if end effector 2 is ferrous and has an indent to receive core magnet 24.

Each coil may be powered with electrical current, becoming an electromagnet that can then push or pull on the core magnet 24, this enables the end effector 2 to move to any location within a hemispherical plane and exert a force. The controller board 6 is in electrical connection with each of the coils. The end effector 2 is able to pivot using bearing or gimbal 25 and is held in place by the top mounting plate 22a. The top mounting plate is connected with conventional mechanical bolts to the heat conductive housing 7. The controller board 6 is connected to a bottom mounting plate 22b which is also connected to the heat conductive housing 7 via mechanical bolts or equivalent.

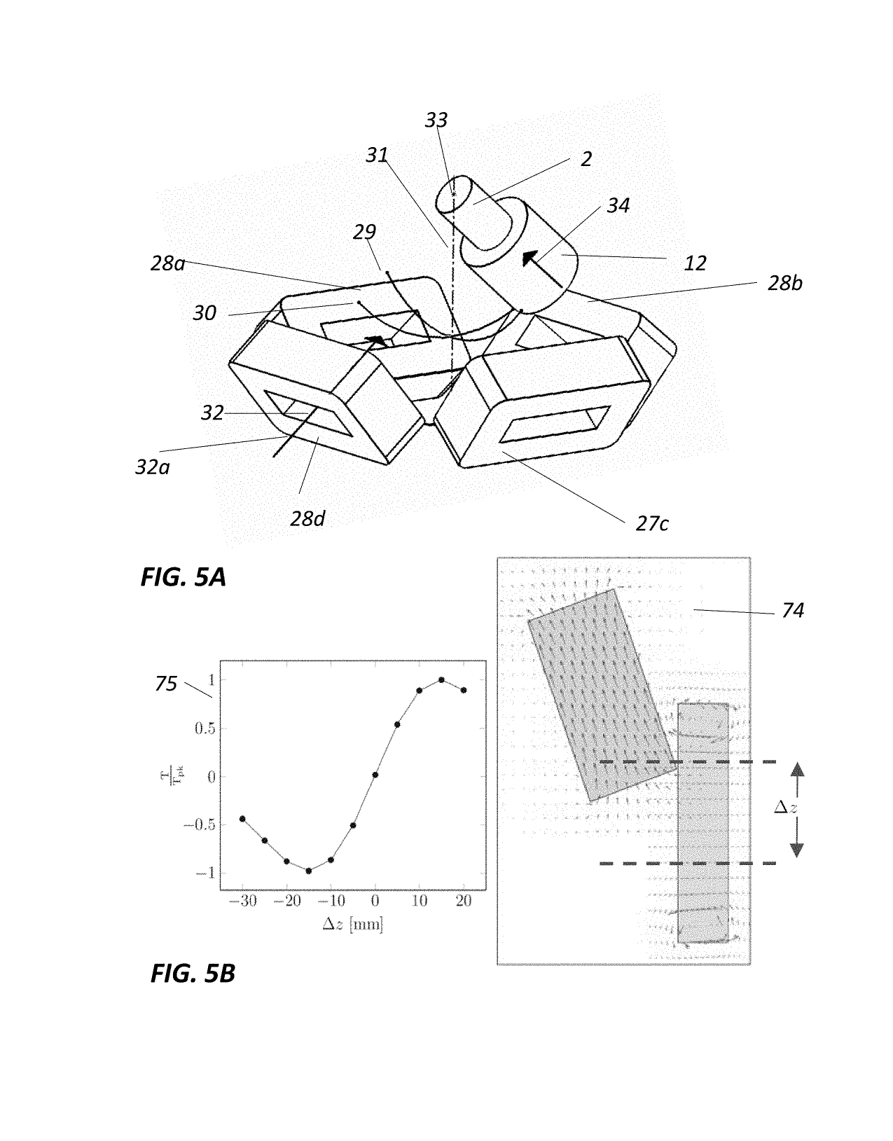

Shown in FIG. 5A is an embodiment of the invention where rectangular prism shaped coils 28a, 28b, 28c, and 28d are tilted outward relative to the void space axis defined by the dashed line 31. The coil magnetic axis 32a is such that the it intersects with the void space axis 31, this means the coils of this embodiment are distributed symmetrically. Within the void space is permanent magnet 12 with a magnet pole axis defined by the directional arrow 34. The permanent magnet 12 is attached to shaft 2 which may pivot on point 33 and move to any position defined by the Y-axis and X-axis, where the Y-axis is defined by line 29 and the X-axis is defined by line 30. This distance from the mid point of the core magnet from the magnetic center of each coil, shown in graph 74 is a prime factor in determining the force response. For example, in the embodiment shown the center of the core magnet in its neutral position is in alignment with a plane formed by the top of each coil. This corresponds to the maximum torque at 20 mm within graph 75 of FIG. 5B.

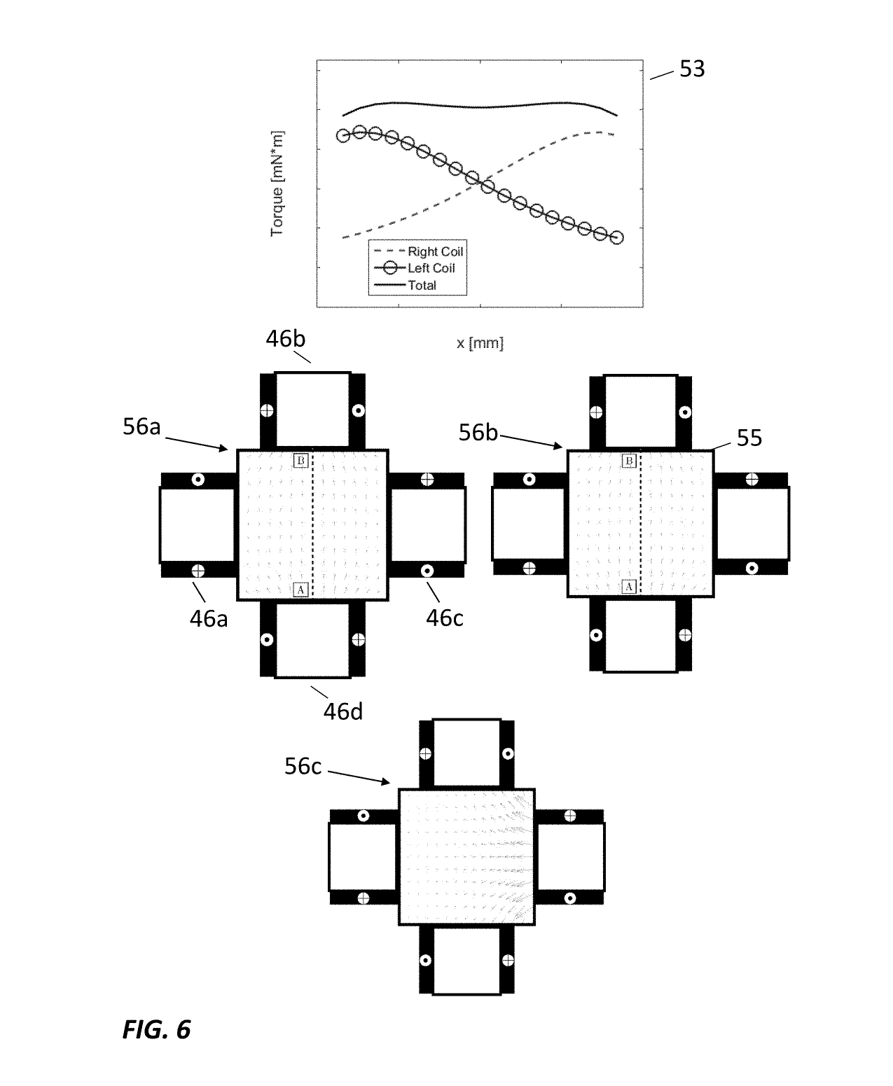

There is limited a number of geometric configurations for coil and magnet placement where the force response of core magnet 12 has an approximately linear and controllable force response. The coils are rectangular to provide a more linear magnetic field dependence when the core magnet 12 is at one of the far corners of its travel, such as when it travels along dashed line 55 shown in FIG. 6. Shown in FIG. 6. Is three example field configurations, on axis configuration 56a, off axis configuration 56b, and single coil configuration 56c. The coil geometry was iterated through computer and lab experimentation to find configurations that produce an approximately linear response. Representative simulation results are shown for on axis force production on the core magnet using two coils in the graph 53. The graph shows that a superposition of two exponentially decaying responses can yield an approximately linear result when appropriately spaced. This principle works best when the permanent magnet 12 travels along the dashed line labelled A to B for the on axis configuration 56a.

The four coils of FIG. 2, labelled as 23a, 23b, 23c, and 23d have their winding direction indicated by coil depictions 46a, 46b, 46c, and 46d, respectively. Shown is a preferred winding arrangement where a dot indicates current direction out of the page, and a cross indicates current direction into the page. If both coils 46b and 46d are powered with current they will create a magnetic field profile analogous to as drawn in 56a. The magnetic field depiction in 56b shows the non-linearity associated with producing force at locations such as the off-axis diagonal line 55.

The shape and resistance of the rectangular coils can be found using the equation of a super ellipse.

$${\vert \frac{x}{a} \vert}^{n} + {\vert \frac{y}{b} \vert}^{n} = 1$$

Where n>2 can be used to set the curvature of the corners for the rectangular coils. The coil resistance should be predictable for a given array size. The value of n can be found by experimentally winding a coil until the theoretical resistance matches the actual resistance of the wound coil. This will compensate for the bend radius that is particular to the winding process used.

To be able to produce a user defined constant force in the X or Y direction for every position, a methodology is needed. A method such as storing a table of values, or a “lookup table”. A lookuptable exists within the control processor as a function or memory bank that produces or stores a force scaling factor for every output position of end effector 2. For example, If a command is given to produce only a Y-axis force at an off axis position, a parasitic force would exists from the Y-axis coils that produce an X-axis force. To remedy this a relatively smaller X-axis force command can also be given. This X-force command would have the same magnitude as the parasitic force, but opposite in sign in order to cancel out the parasitic X force from the original command. This parasitic force exists due to the magnetic field not being uniform across each coil, as can be seen in depiction 56c showing the field of a single coil. This method will make the total force in the desired direction a smaller magnitude than originally possible, due to the secondary parasitic force from the off axis command. The largest force possible for the embodiments shown will be achieved when a pyramid shaped magnet is used, as shown in FIG. 2 item 24. The most optimal coil and magnet geometry will depend on the shape of the magnet.

An analogous method can be used to further improve the fidelity of a stationary wearless sensor solution. A gyroscope measurement device, such as a smartphone can be mounted to the end effector and sensor readings can be mapped for every X-axis and Y-axis position to compensate for slight variations introduced from off axis field readings. The resolution of this map will be constrained by the magnitude of off axis sensor variations, and accuracy of calibration equipment used. For example, consider the coordinate [15,0] which corresponds to an X-axis deflection of 15 degrees from the neutral position and a Y-axis deflection of 0 degrees from the neutral position. If the end effector is moved to the coordinate [15,20] it may report a raw sensor reading of [16,21] due to slight variations in the field. This combination of values can be mapped into the memory of the control processor so that it knows a value of [16,21] actually corresponds to [15,20]. The fidelity, position, control, speed, and feasible frequency range of force effects such as damping and simulated mass (a.k.a inertia) will depend on the quality of this calibration. Field effects from each coil can be mapped if a current sense is in electrical communication with each coil.

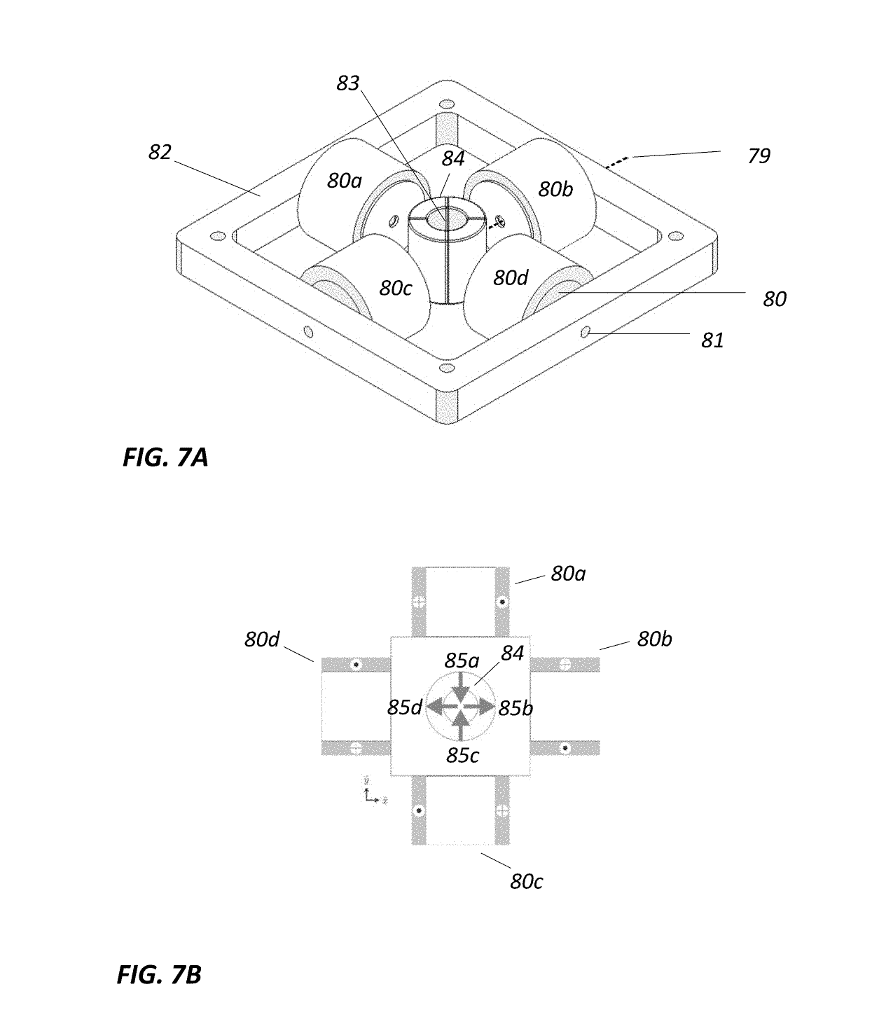

Shown in FIG. 7A is a perspective view of an embodiment of the invention where four coils 80a, 80b, 80c, and 80d are mounted as an array onto housing 82 via mounting screws 81. The coils are symmetrically distributed. Each coil has a central axis 79, shown in FIG. 7A as a dashed line. FIG. 7B is a representative top-down view of the coil array from FIG. 7A.

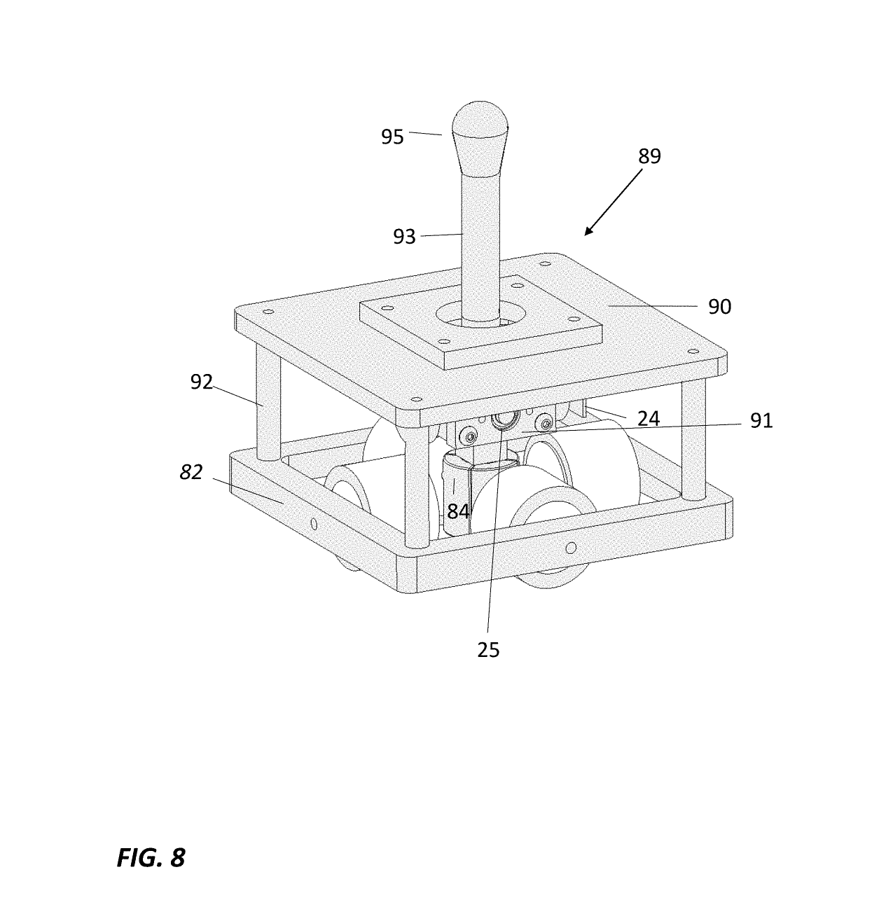

Shown in FIG. 8 is an isometric view of an assembly 89 to enable two-axis force output from the coil array embodiment of FIG. 8. The coils apply electromagnetic force onto the permanent magnet 84 which is connected to shaft or end effector 93. A handle 6 is attached to shaft 95 for ergonomic human interaction. A gimbal or ball joint 25 is connected to shaft 2 in order to provide movement along each axis.

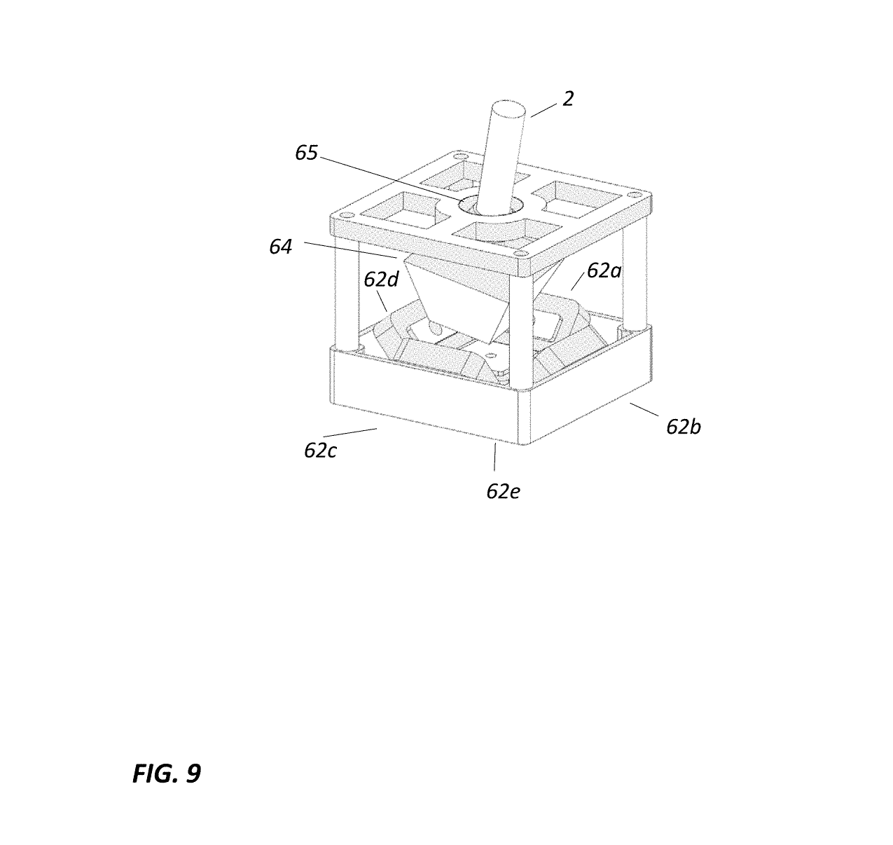

Shown in FIG. 9 is an embodiment of the invention where the movement of core magnet 64 is permitted using a scalable bearing implementation 65. An embodiment that uses a gimbal implementation shown in FIG. 1. will requiring multiple parts. The bearing embodiment of FIG. 9 is scalable to many sizes because a ball joint bearing requires only two parts that move relative to each other. To implement this method a sensing solution is needed to determine the position of the core magnet. A hall effect sensor equivalent to Honeywell HMC 1501/1512 is placed in close proximity to the core magnet 64 and can be used to provide an electrical signal proportional to the angular change in magnetic field caused by the core magnet. A separate sensor can be used for each axis and rigidly mounted without mechanical motion to wear on any wiring. A hall effect sensor that senses the angular displacement of the magnet field enables this functionality by looking at the change in angle of the magnetic field caused by core magnet 64. Shown in this embodiment is a center coil 62e which can be used to create additional force components either attracting the core magnet to the center or radially repelling it from its neutral position.

### Operation for Specification

The embodiment in FIG. 2. is considered in operation when any of the coils have current applied to them and exert a force on the core magnet 24. Referring to FIG. 2, core magnet 24 will receive magnetic force proportional to the current applied to the coils which each have approximately equal resistance. The force on core magnet 24 will be inversely proportional to the distance between the magnet and the coils. Referring to FIG. 6. the current direction is labelled by dot and cross solenoid notation, each opposing coil pairs such as 46b and 46d are wound oppositely to each other and connected to the same driver in series or parallel. This ensures a single current path will simultaneously apply equal and opposite excitation to each coil. The device operates on the magnetic principles of pole attraction and pole repulsion. The sign of the current applied to each of the coils will determine its pole direction. Opposite magnetic poles attract and identical magnetic poles repel each other. Operation of the device includes being able to move the permanent magnet intentionally to any location by applying different voltage levels to the coils.

The embodiment of FIG. 2 will operate with the economic benefit of requiring a permanent magnet with only one magnet pole axis. As well the embodiment in FIG. 2 has rectangular prism coils in order to minimize the losses for diagonal locations within the hemispherical output movement plane of end effector 2. The device can be used to replicate forces using commands from controller board 6, which will apply certain current levels for all two-dimensional locations that the core magnet 24 moves. For example, referring to FIG. 5A, a pivotal-spring-effect can be implemented If the current in each coil was controlled to be proportional to the distance that the permanent magnet moves from the void axis 31, the magnet would feel a force so that the core magnet pole axis 34 is forced to be coincident with the void axis 31 for all positions within the X and Y plane. This distance can be recorded using the electrical output of the sensors. With this information the invention embodiment can replicate a variety of mechanical and organic forces. For example, the forces associated with human joint motion and the forces on shafts that pivot for various vehicle operation. Software written into the controller will enable the device to replicate these forces by storing values of voltage to apply to each coil for each position. Having no mechanical contact for two axis motion makes the invention applicable to human machine interaction. The speed of force effects is such that complicated H-patterns associated with gear shifters can be replicated using software defined detents.

What is claimed is:

1. An input and output device for transmitting and receiving forces within a hemispherical plane comprising:
An array of coils distributed symmetrically for applying a magnetic force on a core magnet.
A housing to mount each of the coils at a controllable orientation so that the position and force exerted on the core magnet is controllable within a hemispherical range of motion.
A shaft to mount the core magnet.
A bearing mechanism attached to the shaft to permit two axis motion by holding the core magnet at a controllable orientation.
A control processor and power source in communication with each electrical coil.
A sensor for each axis that uses the field orientation of the core magnet to determine the position of the shaft. Said machine is capable of replicating dynamic force profiles within a hemispherical plane.

2. The device of claim 1, where an array may exist on both poles of the core magnet.

3. The device of claim 1, where the bearing mechanism can be a ball joint or gimbal.

4. The device of claim 1, where the core magnet can be shaped as a pyramid, cylinder, sphere, rectangular prism, or irregular polygon.

5. The device of claim 1, where the housing is made of heat conductive material and is finned to aid convective cooling.

6. The device of claim 1, where a fan is mounted to the housing to provide convective cooling to the device.

7. A method for producing a user defined constant force at any position within the output range of the device within claim 1, the method comprising storing a lookuptable within the control processor that contains a scaling factor for every output position. A magnitude of current is applied to each axis to produce a force along only one intended axis. The magnitude applied to the unintended axis is equal and opposite to the off axis force caused from non-linearities on the intended axis.

8. The device of claim 1, where software commands on the controller board can mimic detent force patterns of a vehicle gear shifter.

9. The device of claim 1, where a two dimensional lookuptable of sensor values can be used to further increase the accuracy of position data reported from sensors using the magnetic field of the core magnet.

10. The device of claim 1, where the shaft may be ferrous and mount the core magnet using magnetic force of the core magnet acting on the shaft.

11. The device of claim 1, where the core magnet has its single magnetic axis parallel to the shaft longitudinal axis or consists of four symmetrically distributed separate poles that are perpendicular to the shaft axis and alternating.

12. The device of claim 1, where position is determined from a sensor mounted to each axis of a gimbal.
